(19) United States
(12) Patent Application Publication
(10) Pub. No.: US 2014/0040030 A1
(43) Pub. Date: Feb. 6, 2014

(54) MOBILE PAGE MANAGEMENT FOR MERCHANTS LEVERAGING A SOCIAL NETWORKING SYSTEM

(71) Applicants: Kelly Winters, San Francisco, CA (US); Changhao Jiang, San Jose, CA (US); Yuankai Ge, Palo Alto, CA (US); Rohit Dhawan, San Francisco, CA (US)

(72) Inventors: Kelly Winters, San Francisco, CA (US); Changhao Jiang, San Jose, CA (US); Yuankai Ge, Palo Alto, CA (US); Rohit Dhawan, San Francisco, CA (US)

(21) Appl. No.: 13/564,583

(22) Filed: Aug. 1, 2012

(51) Int. Cl. G06Q 30/02; G06Q 50/00

(52) U.S. Cl. CPC G06Q 30/0261; G06Q 50/01
USPC 705/14.58

(57) ABSTRACT

A mobile application enables an administrator of a page in a social networking system to manage the page from a mobile device, separate from a mobile application used to consume content on the social networking system. The administrator application may be used to post content on the page, add fans to the page, delete content posted by fans of the page, generate deals, manage advertising campaigns, and access real-time metrics and insights for the page. The administrator application may also enable a user to manage multiple pages that the user has been designated as an administrator. Loyalty programs may also be designed and implemented in real-time using the administrator application, enabling business owners to customize rewards for users generating check-in events at the place of business.

### BACKGROUND

This invention relates generally to social networking systems, and more particularly to managing pages on a social networking system through a mobile device.

Traditionally, business and their customers have interacted asynchronously, such as advertising messages sent from businesses to potential customers and quality feedback sent from customers to businesses. With the advent of social media, particularly social networking systems, businesses and their customers directly interact in many different ways. Businesses, or merchants, may create pages on a social networking system and provide content about the businesses through their pages. Contests, sweepstakes, and other advertising campaigns may also be operated through a merchant's page on the social networking system. In addition, users may leave feedback about a business's products and service directly on the business's page. This type of instant feedback may help a business implement requested changes quickly and efficiently to get more customers.

Merchants that have pages on social networking systems may allocate large marketing budgets to manage the content that is posted and received on the pages. However, small and mid-size business owners do not have the same resources as large corporations to manage content on pages. For example, a small business owner that owns a local yogurt shop may not have the resources to regularly monitor a page for the yogurt shop because she is busy operating her business. Running advertising campaigns, offers/deals, and/or providing content on the page through user interfaces on the social networking system may be too cumbersome and technical for business owners to learn. In addition, it may take a business owner several days or weeks to respond to comments posted on a page because the yogurt shop owner may not have an Internet-accessible computer at the business. This leads to a loss of valuable customer feedback and a delay in implementing changes. As a result, the tools provided for administrating pages for businesses do not meet the needs of small and mid-size business owners—simplicity, mobility, and efficiency.

Existing methods and tools for managing pages on a social networking system do not address these issues. Specifically, tools for managing deals and content posted on a page on the social networking system have not been effectively provided to businesses attempting to leverage social networking systems. Methods and tools for mobile management of pages that leverage a social networking system are needed to address these issues.

### SUMMARY

A mobile application enables an administrator of a page in a social networking system to manage the page from a mobile device, separate from a mobile application used to consume content on the social networking system. The administrator application may be used to post content on the page, add fans to the page, delete content posted by fans of the page, generate deals, manage advertising campaigns, and access real-time metrics and insights for the page. The administrator application may also enable a user to manage multiple pages that the user has been designated as an administrator. Loyalty programs may also be designed and implemented in real-time using the administrator application, enabling business owners to customize rewards for users generating check-in events at the place of business.

### BRIEF DESCRIPTION OF THE DRAWINGS

FIG. 1 is high level block diagram illustrating mobile page management for merchants leveraging a social networking system, in accordance with an embodiment of the invention.

FIG. 2 is a network diagram of a system for mobile page management for merchants leveraging a social networking system, showing a block diagram of the social networking system, in accordance with an embodiment of the invention.

FIG. 3 is a flowchart of a process of merchants engaging users of a social networking system using a mobile device, in accordance with an embodiment of the invention.

FIG. 4 is a flowchart of a process of customizing deals using a mobile device associated with a page administrator in a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users that are connected on the social networking system may also be referred to as “friends.” Users that are not connected to each other may share mutual friends on the social networking system which may be counted by the social networking system. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with an object may be recorded by the social networking system as an edge. By enabling advertisers to target their advertisements based on user interactions with objects related to a keyword, the advertisements may reach a more receptive audience because the users have already performed an action that is related to the advertisement. For example, a merchandiser that sells Justin Bieber t-shirts, hats, and accessories may target ads for new merchandise to users that have recently performed one of multiple different types of actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is further described in a related application, “Structured Objects and Actions on a Social Networking System,” U.S. application Ser. No. 13/239,340 filed on Sep. 21, 2011, which is hereby incorporated by reference.

Merchants, especially owners of small and medium-sized businesses, may represent their businesses on a social networking system using pages that represent places of business. Pages on a social networking system are nodes that may interact with other nodes, such as posting content, receiving content from users that are “fans” of the pages such that the content is posted on the pages, and being tagged by other users and entities in photos, status updates, comments, and other posts. Administrators of pages, users of a social networking system, may log into the social networking system and perform these interactions acting on behalf of the pages. In this way, users may directly interact with a page on the social networking system, receiving social validation that enhances the user experience. However, administrators of pages may have difficulty in switching between their user persona and page personas using applications operating on mobile devices that are primarily used to consume content posted on the social networking system. A separate mobile page administration application may be developed to enable administrators of pages to better manage the content posted on the pages as well as manage relationships with fans of pages.

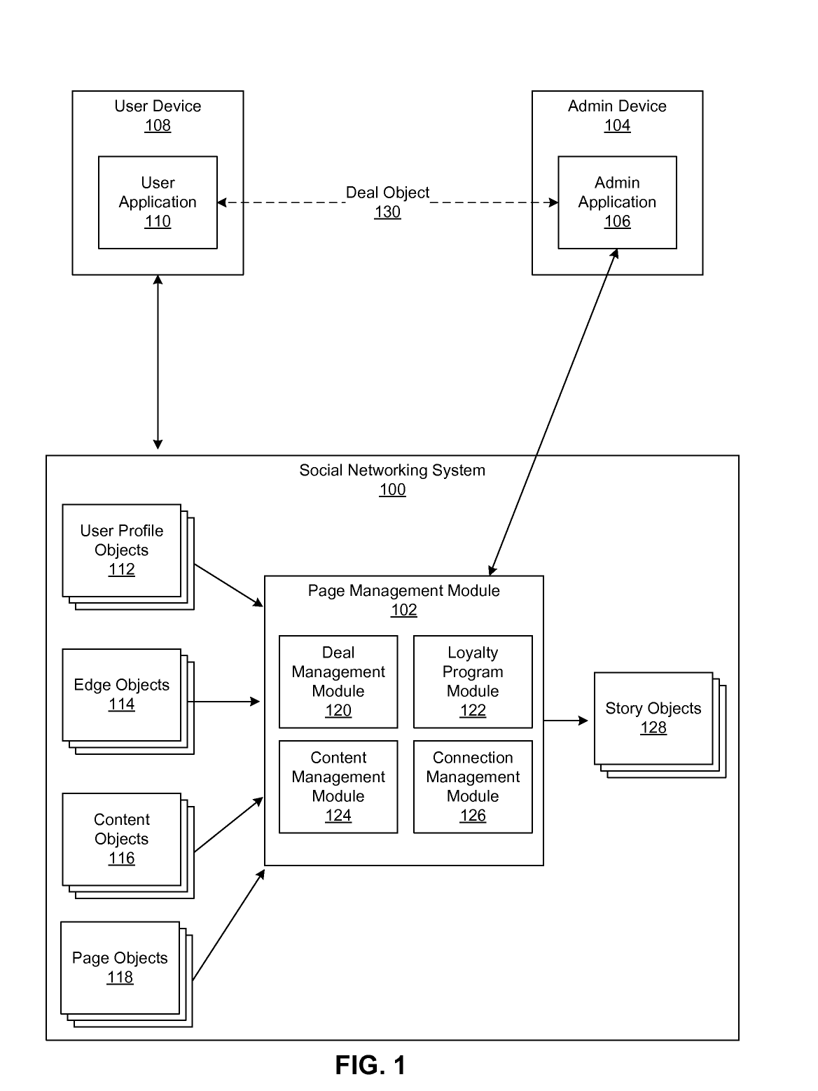

FIG. 1 illustrates mobile page management for merchants leveraging a social networking system, in one embodiment. A social networking system 100 may enable an administrator of a page on the social networking system 100 to interact with a user of the social networking system 100 using a user application 110 operating on a user device 108 to access the social networking system 100. The administrator of the page may interact with the user through an admin application 106 operating on an admin device 104. The social networking system 100 may include a page management module 102 that includes various modules for managing interactions of pages and users, including a deal management module 120, a loyalty program module 122, a content management module 124, and a connection management module 126. The social networking system 100 may also rely on user profile objects 112, edge objects 114, content objects 116, and page objects 118 in providing information to the page management module 102 for enabling page administrators to interact with users that have connected with their respective pages on the social networking system 100. Using the admin application 106, a page administrator may perform the various page management functions described above. In addition, the page administrator may implement a loyalty program based on actions performed by users of the social networking system 100, including check-in events, ordering specific menu items repeatedly, recommending the business on the social networking system 100, and providing a review of the business. The page administrator may also manage deals, or coupons that may be used by the page administrator to advertise products and/or services offered by the place of business represented by the page.

For example, a viewing user using the user device 108 operating the user application 110 may check-in to a place of business represented on the social networking system 100 by a page. The page's administrator may then be notified that the viewing user checked-in at the place of business through an admin application 106 operating on an admin device 104. The notification may include a profile picture of the viewing user and the viewing user's name retrieved from a user profile object 112 associated with the viewing user. Other information may also be included in the notification to the page admin, such as information about whether the viewing user has connected to the page, how many times the viewing user has previously checked-in a the business represented by the page, and any interactions by the viewing user with the page, such as a wall post, comment, shared content, and the like. This information may be retrieved from edge objects 114 associated with the viewing user. Content objects 116 representing photos, status updates, shared links, videos, custom graph objects, and custom graph actions may also be included in the notification to the page admin. For example, if the viewing user has taken a picture of food that was ordered at the restaurant represented by the page, then that content may be included in the notification to the page admin through the admin application 106. Other content, such as reviews, past orders and menu items ordered, and user content generated by the viewing user may be included in the notification sent to the page admin.

The page's administrator may then be provided with several customizable actions, including sending the viewing user a welcome message, providing a deal that includes free or discounted item, providing a coupon to be used on a future visit, displaying an introduction and prompt to join a loyalty program for the page, prompting for a recommendation and/or review, sending a response to a review, and the like. A deal may be defined as any offer generated by a merchant owner of a business to encourage a viewing user to visit the place of business. The admin application 106 operating on the admin device 104 may be configured to enable the page admin to generate custom deals through the admin application 106. Once custom deals are generated for the page, the deals may be distributed throughout the social networking system 100. A deal management module 120 of the page management module 102 may track the deals that are associated with a page, represented by a page object 118 on the social networking system 100. Distributing deals throughout a social networking system is discussed in further detail in a related application, “Distributing Deals via Social Networking System,” U.S. patent application Ser. No. 13,181,347, filed on Jul. 12, 2011, hereby incorporated by reference.

The page admin may select one or more of the customizable actions to be performed and targeted to the viewing user through the admin application 106 operating on the admin device 104. For example, the customizable action may include a personalized welcome message to the viewing user, including the viewing user's name. The action performed by the admin may be stored in an edge object 114 between a user profile object 112 representing the viewing user and a page object 118 representing the page owned by the admin. In one embodiment, the page admin may select an option to automatically welcome a viewing user that checks-in to the place of business represented by the page with a personalized welcome message. In another embodiment, the page admin may select an option to send a personalized welcome to a viewing user of the user application 110 operating on the user device 108 based on the user device 108 being in close proximity to the place of business represented by the page for more than a predetermined threshold amount of time, such as 5 minutes.

A deal object 130 may be generated based on a deal being provided to a viewing user by the social networking system 100. A deal object 130 may be any code that is used to track a deal, including a quick response (QR) code, a bar code, and a whisper code. The deal object 130 may be tracked by the deal management module 120 that is included in the page management module 102 of the social networking system 100. The deal object 130 may include an identifier of the user for which the deal has been provided, an identifier of the page providing the deal, and content object identifier(s) of any content that may be included in the deal, such as images, video, links, and/or text. In one embodiment, the deal object 130 may be associated with an advertisement object on the social networking system 100. The deal object 130 may be generated by the social networking system 100 for presentation on the user application 110 as directed by an admin using the admin application 106 to create the deal. In another embodiment, the deal object 130 may be communicated from the admin application 106 to the user application 110 over a wireless connection connecting the admin device 104 and the user device 108. In a further embodiment, the deal object 130 may be communicated from the admin application 106 to the user application 110 through the social networking system 100 and a code may be manually inputted or scanned into the admin application 106. Generating codes for tracking deals and/or coupons is further discussed in a related application, “Selecting Whisper Codes to Present with Offer,” U.S. patent application Ser. No. 13/398,714, filed on Feb. 15, 2012, hereby incorporated by reference.

Upon receiving a deal represented by the deal object 130 on the user application 110 operating user device 108, the viewing user may select to accept the deal. The acceptance of the deal may be communicated to the social networking system 100 such that the deal management module 120 may track the acceptance rates of deals. The acceptance of the deal may be used by the social networking system 100 to generate a story, represented by a story object 128, to be communicated to other users of the social networking system 100 that may or may not be connected to the viewing user. For example, a story may be highlighted on the page representing the place of business that indicates that the viewing user accepted the deal. In another embodiment, a separate process may recommend deals at the business represented by the page to other users of the social networking system 100 connected to the viewing user that accepted a deal through the user application 110 operating on the user device 108. The recommendations may be in the form of advertisements, in one embodiment. Methods of suggesting deals to connections are described further in related application, “Deals Based on Social Connections,” U.S. patent application Ser. No. 13/181,344, filed on Jul. 12, 2011 and hereby incorporated by reference.

A page admin may also use the admin application 106 operating on the admin device 104 to perform other page management actions, such as connections management, content management, deal management, and designing loyalty programs. Connections management may enable a page admin to add fans to the page and delete content posted by fans. Content management may include adding content to the page by posting text, video, photos, audio, and the like, publishing deals and/or coupons, redeeming coupons by scanning a quick response (QR) code or barcode or by inputting a whisper code, and accessing real-time page metrics and/or analytics. The page management module 102 enables the page admin to access these functionalities from an admin application 106 separate from a user application 110 used by users of the social networking system 100 to consume and interact with content posted on the social networking system 100. The content management module 124 of the page management module 102 may be used to manage content posted to the page. The connection management module 126 may be used to enable page administrators to add users and other pages as connections to the pages they manage. The page admin may also manage advertising campaigns through the admin application 106, in one embodiment. The page management module 102 may communicate with the admin application 106 to enable page administrators to manage advertising campaigns, such as creating advertisements, tracking advertisements, purchasing advertisement inventory, and the like. Advertising campaigns may be managed by the social networking system 100 in a separate process, in another embodiment.

A page admin may also switch between two or more pages that the page admin manages. If a page admin were using a user application 110 designed for consumption of content posted to the social networking system 100, the page admin, a user of the social networking system 100, may have problems distinguishing when he or she is acting on behalf of the page that the user administers and also which page, if he or she manages multiple pages, is being represented. Using the admin application 106, the page admin may clearly switch between pages, eliminating the uncertainty and difficulty involved in using the user application 110. Because the page admin may use the admin application 106 on an admin device 104, which may be a mobile device such as a smart phone or tablet, the page admin may more easily manage content on multiple pages with greater ease and flexibility. Switching between personas on a social networking system is further described in a related application, “Changing Identities in a Social Networking System,” U.S. patent application Ser. No. 13/307,500, filed on Nov. 30, 2011, hereby incorporated by reference.

### System Architecture

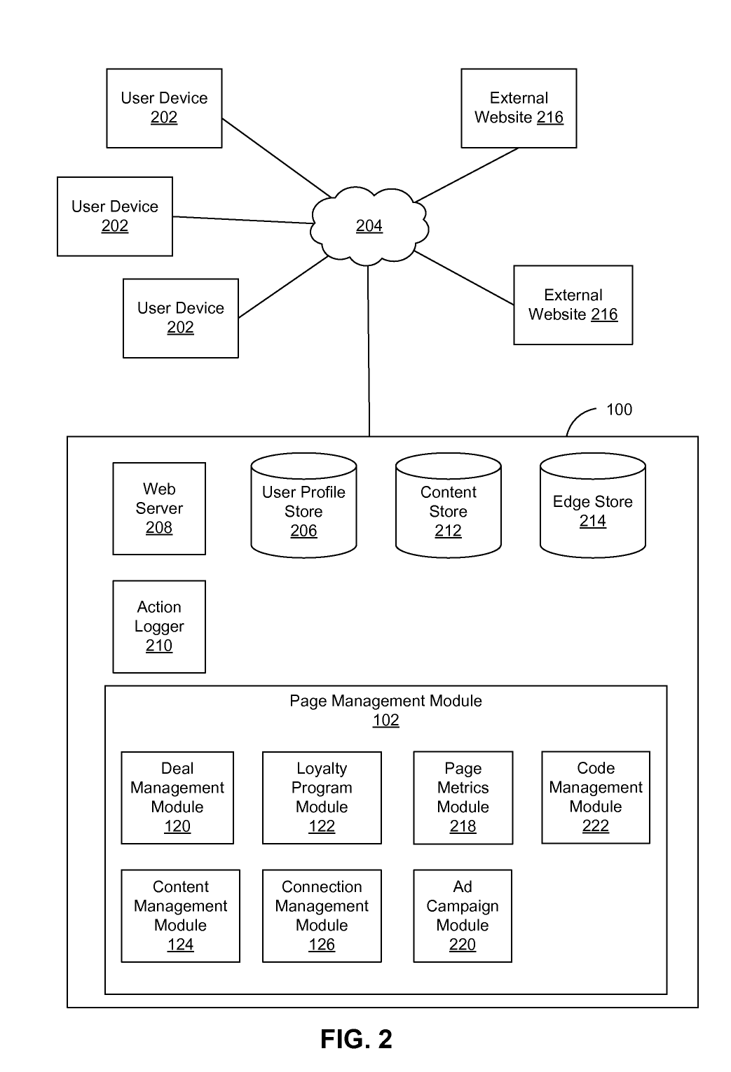

FIG. 2 is a high level block diagram illustrating a system environment suitable for enabling preference portability for users of a social networking system, in accordance with an embodiment of the invention. The system environment comprises one or more user devices 202, the social networking system 100, a network 204, and external websites 216. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, tablet, etc. The user device 202 is configured to communicate via network 204. The user device 202 can execute an application, for example, a browser application that allows a user of the user device 202 to interact with the social networking system 100. In another embodiment, the user device 202 interacts with the social networking system 100 through an application programming interface (API) that runs on the native operating system of the user device 202, such as iOS and ANDROID. A user device 108 and an admin device 104 as illustrated in FIG. 1 are user devices 202 as illustrated in FIG. 2 and described above.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a user profile store 206, a web server 208, an action logger 210, a content store 212, an edge store 214, a code management module 222, a page management module 102 that further comprises a page metrics module 218, an ad campaign module 220, a deal management module 120, a loyalty program module 122, a content management module 124, and a connection management module 126. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more user devices 202; the web server 208 serves web pages, as well as other web-related content, such as Java, Flash, XML, and so forth. The web server 208 may provide the functionality of receiving and routing messages between the social networking system 100 and the user devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native user device operating systems, such as iOS, ANDROID, webOS, and RIM.

The action logger 210 is capable of receiving communications from the web server 208 about user actions on and/or off the social networking system 100. The action logger 210 populates an action log with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communication information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for users are stored as user profile objects 108 in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile store 206 also maintains references to the actions stored in an action log and performed on objects in the content store 212.

The edge store 214 stores the information describing connections between users and other objects on the social networking system 100 in edge objects 110. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge store 214 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 214, in one embodiment. For example, a user that plays multiple songs from Lady Gaga's album, “Born This Way,” may have multiple edge objects for the songs, but only one edge object for Lady Gaga.

A page management module 102 enables administrators of pages of a social networking system 100 to manage content on their pages, add other users and entities as connections to the pages, access analytics about their pages, and manage advertising campaigns to promote their pages. A page management module 102 includes a deal management module 120, a loyalty program module 122, a content management module 124, a connection management module 126, a page metrics module 218, an ad campaign module 220, and a code management module 222. The modules included in the page management module 102 may operate independently and asynchronously to perform the described functions.

A deal management module 120 enables page administrators to generate, track, and manage deals offered to fans of pages. A deal may include an offer for a free or discounted product or service offered by the merchant, in one embodiment. A template of deals may be generated by the social networking system 100 that may be customizable by the merchant page administrators, such as coupons for a service where the name of the service may be inputted by the merchant as well as the amount of the discount. Terms of a deal may be inputted as user input or selected through a user interface. In one embodiment, page administrators may upload content, such as images, video, and text, which may be included in a deal to be offered to fans, or users that have connected to a page. Terms may also be recognized by the social networking system 100, in one embodiment. For example, a deal for 20% off may be inputted through an admin application 106 as voice input. The social networking system 100, through a separate process, may recognize the voice input and generate the terms of the deal. The deal management module 120 may also track utilization of deals by users of the social networking system 100 as well as other metrics about deals, such as conversion rate, click-through rate, reach, virality, and other advertising metrics.

A loyalty program module 122 enables page administrators to use loyalty programs to incentivize users of a social networking system 100 to engage with a page as well as the place of business represented by the page on the social networking system 100. For example, a loyalty program module 122 may have one or more template loyalty programs which may be selected by the page administrator. A loyalty program may reward a user that performs one or more actions, such as a first check-in event using a mobile device at the place of business represented by a page, the fifth check-in, the tenth check-in, and so on. The actions that must be performed to receive a reward, or the achievements that must be completed to receive a deal, may be customized or defined for the page, such as ordering ten cups of coffee at a cafe, spending more than $100 in one visit at a fashion boutique, or exercising for more than an hour at a gym. In another embodiment, a loyalty program may include content uploaded by the page admin through the admin application 106, such as a customized welcome message from the merchant in audio, video, or text format, a congratulations message after reaching a certain milestone or achievement defined by the merchant, as well as other messages that may incentive users to complete milestones or achievements. The loyalty program module 122 of the page management module 102 may receive the content generated by the page admin through the admin application 106 and provide a user interface for the page admin to attach the content to the desired messages. Other loyalty programs may be customized and implemented by page administrators, such as providing a coupon when a user checks-in with other users at the place of business represented by the page, providing a coupon to a user conditioned on the user promoting the page representing the place of business in content uploaded by the user, providing a coupon based on a user generating an event on the social networking system 100 to be held at the place of business represented by the page, and so on. In this way, rewards may be greater, or in greater intensity, as higher levels of achievements are completed.

A content management module 124 provides page administrators an interface to manage content that is posted on pages of the social networking system 100. Page administrators may, through an admin application 106 operating on a user device 202, add or delete content from pages on the social networking system 100 that they manage, such as text, video, photos, audio, comments, and links posted to the pages. Other content, such as events on the social networking system 100 hosted by a page (as represented by a page administrator), photos in which a page was tagged by fans of the page, and custom graph objects and custom graph actions performed by an external system associated with a page may also be managed through the content management module 124. Additionally, page administrators may publish to pages on the social networking system 100 deals that are generated by the deal management module 120 through the content management module 124, in one embodiment.

A connection management module 126 enables a page administrator to manage connections for a page on a social networking system 100 through an admin application 106 operating on a user device 202. A page administrator may add connections, such as users and other pages, to the page being managed. In one embodiment, a page administrator may delete and/or block connections from posting on the page. From the admin application 106, a page administrator may selectively add new connections through a user interface, search the social networking system 100 for new connections to add, and delete and/or block existing connections.

A page metrics module 218 generates and provides metrics about pages on a social networking system 100 to page administrators through an admin application 106. The page metrics module 218 may generate metrics such as total number of fans, or the total number of users that have expressed an interest in the page, a number of content posts on the page in specified time period, the number of unique people who have created a story or content post about a page on the social networking system 100 in the last 7 days, the number of secondary connections or friends of fans, and demographics information about fans, such as percentages of males and females in total and across age groups, countries represented, cities, languages spoken. Other metrics may also include how users arrived at the page and how users on the social networking system 100 were reached. An organic reach metric measures the number of unique people that saw content from the page in a news feed or communication channel from the social networking system 100. A paid reach metric measures the number of unique people who saw an advertisement that pointed to the page. A viral reach metric measures the number of unique people who saw a story about the page published by a friend or connection on the social networking system 100. A total reach metric measures the number of unique people who saw any content associated with the page. Additional metrics may include a number of unique page views, a number of unique visitors to the page, and advertising conversion metrics to measure the effectiveness of the coupons and/or loyalty programs implemented by the page administrator.

An ad campaign module 220 provides an interface for page administrators to manage advertisements related to pages on the social networking system 100 through an admin application 106 operating on a user device 202. The ad campaign module 220 may provide a user interface through the admin application 106 for viewing advertising metrics information about paid advertisements for the business represented by the page. The ad campaign module 220 may also enable a page administrator to generate advertising creative and purchase advertisement inventory through the admin application 106. For example, a user-generated photo and advertising copy (the text of the advertisement) may be uploaded from the user device 202 to the social networking system 100 using the admin application 106 through a user interface provided by the ad campaign module 220 to enable the page administrator to quickly and efficiently create a small banner advertisement for publishing on the social networking system 100.

The ad campaign module 220 may further enable a page administrator to create and manage multiple advertising campaigns through the admin application 106 as well as to select separate targeting criteria for multiple ad campaigns and view real-time metrics of the advertisements, in one embodiment. For example, a page administrator may create an advertising campaign directed towards fans that check-in to the place of business regularly that gives them a deal on a product or service offered by the business. The targeting criteria for this deal would target users that have checked-in to the place of business more than a predetermined threshold number of times. Another advertising campaign may be directed towards users of the social networking system 100 that are not yet connected to the page representing the business. The page administrator may wish to sponsor stories related to the page and publish these “sponsored stories” as advertisements directed at users that have not yet connected to the page. This advertising campaign may have different targeting criteria, such as users connected to fans of the page, users that live near the place of business, and users that are interested in topics related to the business. The page administrator for the page may manage these multiple advertising campaigns through an admin application 106 that communicates with the ad campaign module 220. In one embodiment, a page administrator may choose to enable other entities to advertise to users checking at the business represented by the page. The social networking system 100 may enable a marketplace for the business owner to deliver advertisements specifically catered to customers at the business. In another embodiment, other information gathered by the social networking system 100 may be used to optimize monetization of advertisements displayed in relation to check-in events at the place of business. Providing advertisements based on location is further discussed in a related application, “Location Event Advertising,” U.S. patent application Ser. No. 13/105,708, filed on May 11, 2011, hereby incorporated by reference.

A code management module 222 manages codes generated for deal tracking by the page management module 102. Through an admin application 106, a page administrator may view analytical information about the codes generated for deals that are provided in the social networking system 100 related to the page that the page administrator manages, such as demographics of users accepting and redeeming the deal, how the deal was presented to users and conversion rates for each type of presentation (organic, paid, and viral), and other metrics similar to those metrics provided by the page metrics module 218. Codes may be added, modified, and/or deleted through the admin application 106 communicating with the code management module 222.

The code management module 222 also enables a page administrator to generate a code, such as a quick response (QR) code, bar code, or whisper code, from the admin application 106 for immediate use by a user of the social networking system 100. For example, if a page administrator would like to create print media, such as a flyer or a physical coupon, the code management module 222 may enable the admin application 106 to generate and produce a code for the page administrator to use in on the print media, such as a whisper code or a QR code, in one embodiment. The admin application 106 may email this code, save the code as a picture on the user device 202 operating the admin application 106, or communicate the code through one or more social networking systems, including the social networking system 100.

The code management module 222 also verifies whether a code is still valid. A page administrator may generate deals that are offered for a limited time or that have limited quantity. The code management module 222 may be used to verify that the deal represented by the code is active and able to be redeemed by the user. Upon redemption of a deal by a user presenting the code, the admin application 106 may be used to scan the code or input the whisper code provided by the user, either presented on the user device 202 associated with the user redeeming the deal or on print media.

### Page Administrators Leveraging a Social Networking System

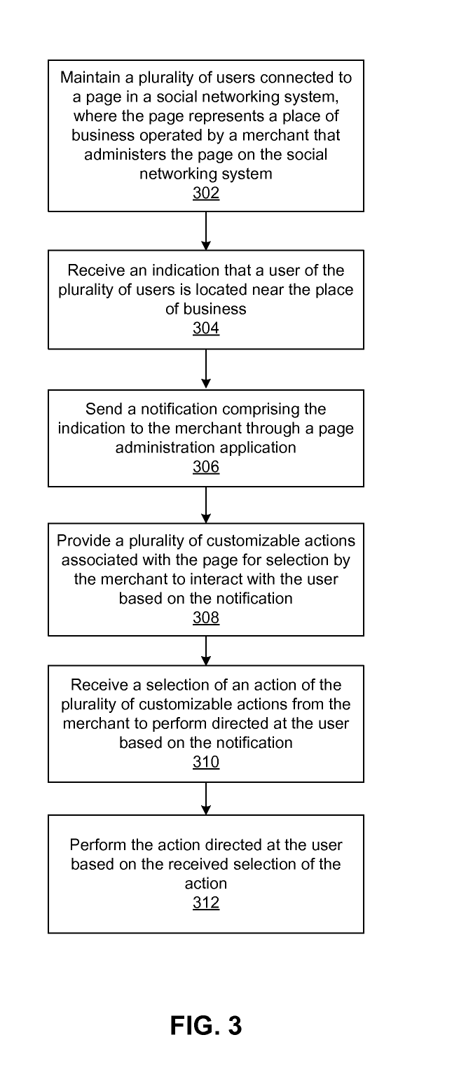

FIG. 3 illustrates a flowchart depicting a process of merchants engaging users of a social networking system using a mobile device, in accordance with an embodiment of the invention. A social networking system 100 maintains 302 a plurality of users connected to a page in a social networking system, where the page represents a place of business operated by a merchant that administers the page on the social networking system. The plurality of users connected to a page in a social networking system 100 may also be referred to as fans of the page. In one embodiment, a user may become a fan of a page by checking-into a place of business represented by the page on the social networking system 100. In another embodiment, a user may become a fan of a page by checking-into a place of business represented by the page more than a predetermined threshold number of times.

A social networking system receives 304 an indication that a user of the plurality of users is located near the place of business. The indication may be based on a check-in event by the user using a user application 110 operating on a user device 202, in one embodiment. The indication may also be based on a message sent from the user application 110 operating on the user device 202 that includes geographic positioning system (GPS) information and/or other location information, in another embodiment. In a further embodiment, a user may be automatically checked-in to a place of business based on GPS information and a period of time elapsing without the user's location changing from the place of business.

After an indication is received 304 that a user of the plurality of users is located near the place of business, a notification is sent 306 to the merchant comprising the indication through a page administration application. A merchant, or a page administrator of the page representing the place of business, may access a page administration application operating on a user device 202 that is separate from a user application of the social networking system 100. The notification may comprise a message sent through one or more communication channels of the social networking system 100, such as an email, a message on the social networking system 100, and a pop-up notification message operating through the page administration application on the user device 202 using a mobile operating system such as iOS, ANDROID, webOS, and RIM. In one embodiment, a page may have more than one page administrator managing the page using one or more user devices 202 operating a page administration application. The notification would be sent 306 to all user devices 202 operating a page administration application for all page administrators of the page.

After the notification is sent 306 to the merchant through the page administration application, a plurality of customizable actions associated with the page is provided 308 for selection by the merchant to interact with the user based on the notification. Customizable actions may include sending the user that is located near the place of business a customized welcome message, an advertisement, an invitation to join a loyalty program, and/or a deal or coupon with customizable terms. Customizable terms may include expiration dates, one-time deals, instant deals that must be redeemed within a certain amount of time (e.g., 30 minutes), repeating offers, discounts, bundles, cross-promotional deals with other businesses, a referral program to invite other users connected to the user to visit the business, incentives for providing reviews, and so on. In one embodiment, the customizable actions may include actions previously used by the page administrator using the page administration application. In another embodiment, a plurality of template actions may be provided 308 by the social networking system 100. In a further embodiment, a page administrator may access the social networking system 100 to configure the customizable actions through a user device 202, such as a computer. Once configured, the stored actions may then be provided 408 to the merchant based on the notification.

As mentioned above, the terms of a deal may be completely customizable, such as receiving a free cocktail after spending a minimum of $20 at a bar represented by a page on the social networking system 100. Conditional statements may be inputted into and recognized by the social networking system 100, in one embodiment. In evaluating the conditional statements, the social networking system 100 may rely on the page management module 102 in verifying that the terms of the deal have been met by the user. In another embodiment, the page administrator may simple enter text that is displayed in the deal that indicates the terms of the deal.

A page administrator may select from the provided 308 plurality of customizable actions associated with the page to interact with the user based on the notification. This selection may be received 310 by the social networking system from the page administration application operating on a user device 202. The page administrator may select one or more actions from the provided 308 plurality of customizable actions associated with the page. In one embodiment, the page administrator may also select delivery methods for the actions, such as timing delays between messages, platforms on which messages are delivered (Short Message Service (SMS) text, email, and/or other communication channel on the social networking system), and so forth. For example, an advertisement may be selected to be sent to the user that is located near the place of business represented by the page. The advertisement may be in the form of a display ad, featuring weekly specials at the place of business. The page administrator may also select to send the advertisement immediately as a pop-up notification through the user application operating on the user device 202. This delivery method may be priced differently than other delivery methods, such as a banner advertisement in the user application or an automatic check-in event that includes the advertisement as part of the confirmation of the check-in event, in one embodiment.

After the selection of an action of the plurality of customizable actions is received 310 from the merchant, the action is performed 312 directed at the user based on the received selection of the action. For example, a merchant, after being notified of a potential customer (i.e., the user that is located near the place of business represented by the page), may decide to create a one-time use deal to entice the user to visit the business. The action, sending a one-time use deal, may be selected by the merchant to be performed 312 directed at the user. Other actions, such as sponsoring a story about an automated check-in event by the user for distribution to other connected users on the social networking system 100 pursuant to privacy settings and previous authorizations in the social networking system 100, may be performed 312 directed at other users, in one embodiment.

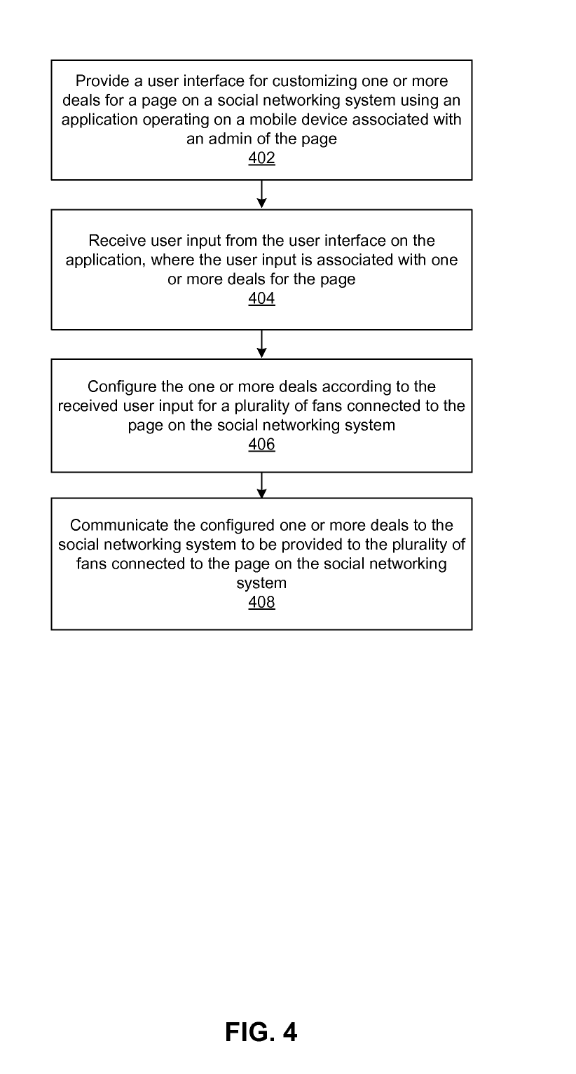

Having described how a social networking system 100 may be used to receive and send indications that users are located near a place of business that is represented by a page in the social networking system 100, a process of customizing deals using a mobile device is now described. FIG. 4 illustrates a flowchart depicting a process of customizing deals using a mobile device associated with a page administrator in a social networking system, in accordance with an embodiment of the invention. A user interface for customizing one or more deals for a page on a social networking system using an application operating on a mobile device associated with an admin of the page is provided 402. In one embodiment, the user interface is provided on the application operating on the mobile device, such as a native application operating on the operating system of the mobile device. In another embodiment, the user interface is provided on a browser application operating on the mobile device, such as a mobile web application that operates on the browser that connects to the Internet on the mobile device.

User input may be received 404 from the user interface on the application, where the user input is associated with one or more deals for the page. User input may include text, photo upload, video upload, audio upload, file transfer, link reference, gesture input, voice command, and the like. The user input may include terms of a deal, such as an expiration date, a link to an explanation of terms, a selection of template terms, template deals, and the like. The user input may also include a selection of a link provided in the interface to select a previously used deal. The user input may also include one or more gestures, clicks, and/or selections of links on the user interface for customizing the one or more deals for the page. Links included in the user interface may include one or more generic terms of deals, such as a coupon for a percentage off the final sale, a retail value for the service or product being offered as a deal, a quantity of deals to be offered, and a specified time period of redeeming the deal.

After user input has been received 404 that is associated with one or more deals for the page, the one or more deals are configured 406 according to the received user input for a plurality of fans connected to the page on the social networking system. In one embodiment, configuring 406 the one or more deals involves associating the received user input with the one or more deals in the social networking system 100. For example, if the user input includes terms of a deal, such as a coupon for $50 off a Britney Spears Concert that must be used in the next 2 weeks, then those conditional statements, or terms, are stored in association with the deal.

The configured one or more deals are communicated 408 to the social networking system to be provided to the plurality of fans connected to the page on the social networking system. The configured deals are communicated 408, in one embodiment, through an application programming interface (API) from the user device 202 operating the admin application 106. In another embodiment, the configured deals are communicated 408 to the social networking system 100 through a web server 208 on the social networking system 100.

In one embodiment, the user interface may also include functionality to enable a page administrator to view analytic metrics about the deals from a mobile device operating the admin application 106 that provides the user interface. In another embodiment, a page administrator may be able to scan a coupon presented by a user of the social networking system 100, such as scanning a quick response (QR) code or bar code, using the admin application 106. In a further embodiment, a page administrator may be able to accept a coupon presented by a user through the admin application 106 using a wireless connection with the user device associated with the user, such as over Bluetooth, WiFi, or other wireless communication protocol. For example, a special deal may be generated by the page administrator for a user. The deal may be electronically communicated to the user through the social networking system, in one embodiment. In another embodiment, the deal may be communicated to the user through a wireless connection with the user device, such as a WiFi network at the place of business or through a Bluetooth connection. The deal may then be accepted by the user through the user application 110 which communicates the acceptance over the wireless connection to the admin application 106.

### Loyalty Programs for Pages in a Social Networking System

In other embodiments, the social networking system 100 may enable a page administrator to design and implement a customizable loyalty program for the business represented by the page on the social networking system 100. Social networking systems may have previously relied on a single approach for all businesses wishing to implement a loyalty program, such as giving a “mayor” of a business, or a user that has checked-in multiple times exceeding a predetermined threshold, or otherwise determined by an algorithm, a special discount at the business. Other loyalty programs, such as loyalty programs tied to a credit card used by the user at the place of business, may be earn points that are specific to the loyalty program, such as points for airline vouchers or donating to a cause. In both situations, merchants are restricted to the predetermined loyalty program provided by the social networking system.

A customizable loyalty program may be provided the social networking system 100 that enables a page administrator to design and implement a loyalty program that is tailored to the business that is represented by the page. For example, a high volume business, such as a coffee shop, may have many regular customers that grab a coffee on the way to work. This business may wish to reward those customers without having a “mayor” type of loyalty program, and instead implement a rewards program that entices users to check-in each time they visit the business. The coffee shop may provide a reward, such as a larger size of coffee for the price of a smaller size, based on a first check-n, a fifth check-in and a tenth check-in. Other rewards may be given for the fifth and tenth check-ins, such as a free cookie. Additional rewards may be given on checking-in more than 30 times in a month. The admin application 106 may be used to capture the terms and conditions of the customized loyalty program for the page.

Other types of businesses may provide loyalty programs that are customized to their businesses. For example, instead of relying on check-ins as the metric upon which a loyalty program is based, a page administrator may wish to reward fans of their page that bring other users to the business, especially if the other users are not already fans of the page or have never been to the business. A loyalty program that rewards a user that brings friends to a local barbeque restaurant may give a special deal that rewards the user for bringing in one, five, or ten different users to the restaurant in a specified time period. To verify that the user did bring in the other users, the other users may be sent a notification to their mobile devices to show to the page administrator using the admin application 106. In another embodiment, the page administrator may request the other users that were brought into the restaurant to sign-in using the admin application 106 to record that they were present. In a further embodiment, a social networking system 100 may enable user devices 202 to automatically check-in users at the restaurant represented by the page. The admin application 106 may then be used to assign credit for the other users to the user requesting the credit at the restaurant.

In a further embodiment, businesses may reward fans of their pages that refer business and/or promote the businesses on the social networking system 100, such as providing testimonials, reviews, recommendations, and providing content on the pages for the businesses. This type of loyalty program may be designed by the page administrator using the admin application 106 through a user interface, such as selecting types of content to be rewarded, communicating the users that have provided this type of promotional activity on the social networking system 100 to the page administrator through the user interface in order to reward them, and selecting a “fan of the week” based on this type of promotional activity. This type of loyalty program may not need to be “signed up” for by the fans of the page, in one embodiment.

As pages of the social networking system 100 design and implement different loyalty programs, the loyalty programs may be promoted and displayed as nodes in the social networking system 100 associated with the pages, in one embodiment. As a result, the action of a user joining a loyalty program for a page may be communicated as a story within the social networking system 100 and may be sponsored by the page for distribution to other users connected to the user. Popular loyalty programs among a user's connections may be presented to the user as a suggestion to join, in one embodiment. Furthermore, the social networking system 100 may provide a user with the pages that are popular among the user's connections.

In one embodiment, fans of a page that have joined the page's loyalty program may be given special treatment by the page in exchange for contributing to the social graph, such as no ads being presented on the page when viewed by the fans, receiving special deals only available to loyalty program participants, and special invites to events held at the business as a result of joining the loyalty program. The special event invites may be generated using the admin application 106, in one embodiment. Fans of the loyalty page may also receive credits from the merchant for completing certain actions, such as inviting others to be fans of the page, bringing in multiple guests to the business, and so forth. These credits may then be accumulated to be redeemed for rewards. Credits may also be used in a social networking system in other applications, such as games, virtual gifts, and the like.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
maintaining profiles for a plurality of users who have connected to a page in a social networking system, where the page represents a place of business operated by a merchant that administers the page;
receiving an indication that a subject user of the plurality of users is located near the place of business;
sending a notification comprising the indication to the merchant through a page administration application;
providing a plurality of customizable actions associated with the page for selection by the merchant to interact with the subject user based on the notification;
receiving a selection of an action of the plurality of customizable actions from the merchant to perform directed at the subject user based on the notification; and
performing the action directed at the subject user in the social networking system based on the received selection of the action.

2. The method of claim 1, wherein receiving the indication that a user of the plurality of users is located near the place of business further comprises receiving one or more geographic location coordinates from a user device associated with the subject user, where the one or more geographic location coordinates indicates a position near the place of business.

3. The method of claim 1, wherein receiving the indication that a subject user of the plurality of users is located near the place of business further comprises receiving a check-in event including location information from a user device associated with the subject user, where the location information indicates a position near the place of business.

4. The method of claim 1, wherein receiving the indication that a subject user of the plurality of users is located near the place of business further comprises receiving a communication from a user device associated with the subject user indicating that the subject user is located at the place of business.

5. The method of claim 1, wherein sending a notification comprising the indication to the merchant through a page administration application further comprises:
retrieving user profile information associated with the subject user from the social networking system; and
sending the notification to the merchant through the page administration application, where the notification further comprises the retrieved user profile information.

6. The method of claim 1, wherein sending a notification comprising the indication to the merchant through a page administration application further comprises:
retrieving edge information associated with the subject user from the social networking system; and
sending the notification to the merchant through the page administration application, where the notification further comprises the retrieved edge information.

7. The method of claim 1, wherein providing a plurality of customizable actions associated with the page for selection by the merchant to interact with the subject user based on the notification further comprises:
retrieving user profile information associated with the subject user from the social networking system;
configuring a welcome message with the user profile information for sending to the subject user; and
providing the configured welcome message for sending to the subject user as one of the plurality of customizable actions associated with the page for selection by the merchant.

8. The method of claim 1, wherein providing a plurality of customizable actions associated with the page for selection by the merchant to interact with the subject user based on the notification further comprises:
retrieving edge information associated with the user from the social networking system, where the edge information includes one or more products purchased by one or more other users connected to the subject user on the social networking system at the place of business;
determining a recommendation for a product offered by the place of business based on the retrieved edge information; and
providing an advertisement for the determined recommendation for the product for sending to the subject user as one of the plurality of customizable actions associated with the page for selection by the merchant.

9. The method of claim 1, wherein providing a plurality of customizable actions associated with the page for selection by the merchant to interact with the subject user based on the notification further comprises:
retrieving edge information associated with the user from the social networking system, where the edge information includes one or more products purchased by one or more other users connected to the user on the social networking system at the place of business;
generating a deal for a product offered by the place of business based on the retrieved edge information; and
providing the generated deal for the product for sending to the subject user as one of the plurality of customizable actions associated with the page for selection by the merchant.

10. The method of claim 1, wherein providing a plurality of customizable actions associated with the page for selection by the merchant to interact with the subject user based on the notification further comprises:
retrieving edge information associated with the subject user from the social networking system, where the edge information includes one or more products purchased by the user on the social networking system at the place of business;
generating a deal for a product offered by the place of business based on the retrieved edge information; and
providing the generated deal for the product for sending to the subject user as one of the plurality of customizable actions associated with the page for selection by the merchant.

11. The method of claim 1, wherein providing a plurality of customizable actions associated with the page for selection by the merchant to interact with the subject user based on the notification further comprises:
retrieving edge information associated with the subject user from the social networking system, where the edge information includes historical information about the user in relation to the place of business;
generating a deal for a product offered by the place of business based on the retrieved edge information; and
providing the generated deal for the product for sending to the subject user as one of the plurality of customizable actions associated with the page for selection by the merchant.

12. The method of claim 1, wherein providing a plurality of customizable actions associated with the page for selection by the merchant to interact with the subject user based on the notification further comprises:
retrieving edge information associated with the subject user from the social networking system, where the edge information includes a confirmation that the subject user is connected to the page representing the place of business on the social networking system;
generating an automatic check-in event at the place of business for the subject user based on the retrieved edge information; and
providing the generated automatic check-in event at the place of business for the subject user as one of the plurality of customizable actions associated with the page for selection by the merchant.

13. The method of claim 1, wherein providing a plurality of customizable actions associated with the page for selection by the merchant to interact with the subject user based on the notification further comprises:
retrieving edge information associated with the subject user from the social networking system, where the edge information includes information about one or more other users connected to the user on the social networking system that have generated interactions at the place of business represented by the page on the social networking system;
generating an advertisement for the place of business for the subject user based on the retrieved edge information; and
providing the generated advertisement for the place of business for the subject user as one of the plurality of customizable actions associated with the page for selection by the merchant.

14. The method of claim 1, wherein providing a plurality of customizable actions associated with the page for selection by the merchant to interact with the subject user based on the notification further comprises:
retrieving edge information associated with the subject user from the social networking system, where the edge information includes a confirmation that the subject user is not connected to the page representing the place of business on the social networking system;
generating an advertisement for the place of business for the user based on the retrieved edge information; and
providing the generated advertisement for the place of business for the subject user as one of the plurality of customizable actions associated with the page for selection by the merchant.

15. The method of claim 1, wherein receiving a selection of an action of the plurality of customizable actions from the merchant to perform directed at the subject user based on the notification further comprises:
receiving a web page request from a user device associated with an administrator of the page operating the page administration application, where the web page request includes the selection of the action.

16. The method of claim 1, wherein receiving a selection of an action of the plurality of customizable actions from the merchant to perform directed at the subject user based on the notification further comprises:
receiving an application programming interface (API) request from a user device associated with an administrator of the page operating the page administration application, where the API request includes the selection of the action.

17. A method comprising:
providing a user interface for customizing one or more deals for a page on a social networking system, the user interface provided in an application operating on a mobile device associated with an admin of the page;
receiving user input from the user using the user interface provided on the application, the user input related to one or more of the deals associated with the page;
determining a configuration of the one or more deals according to the received user input for providing the one or more deals to a plurality of fans connected to the page on the social networking system; and
communicating the configuration of the one or more deals to the social networking system.

18. The method of claim 17, wherein an admin of the page further comprises a user of the social networking system designated by an owner of the page to administer the page.

19. The method of claim 17, wherein receiving user input from the user using the user interface provided on the application further comprises:
receiving a selection of one or more links in the user interface, where the one or more links modify a term for one or more deals for the page.

20. The method of claim 17, wherein receiving user input from the user using the user interface provided on the application further comprises:
receiving a voice command from the mobile device, where the voice command includes a term for one or more deals for the page.

21. The method of claim 17, wherein determining a configuration of the one or more deals according to the received user input for providing the one or more deals to a plurality of fans connected to the page on the social networking system further comprises:
determining a term of a deal of the one or more deals based on the received user input; and
configuring the deal to include the determined term.

22. The method of claim 17, wherein determining a configuration of the one or more deals according to the received user input for providing the one or more deals to a plurality of fans connected to the page on the social networking system further comprises:
retrieving a deal associated with the page from the social networking system;
determining a term of a deal of the one or more deals based on the received user input; and
configuring the deal to include the determined term.

23. The method of claim 17, wherein determining a configuration of the one or more deals according to the received user input for providing the one or more deals to a plurality of fans connected to the page on the social networking system further comprises:
retrieving a deal associated with the page from the social networking system, where the deal comprises a template that includes one or more customizable fields;
determining one or more values for the template that matches the one or more customizable fields based on the received user input; and
configuring the deal to include the one or more values for the template.

24. The method of claim 17, further comprising:
providing in the user interface on the application operating on the mobile device associated with the admin of the page a link for displaying one or more metrics for the one or more deals associated with the page on the social networking system;
receiving a selection of the link for displaying the one or more metrics for the one or more deals associated with the page on the social networking system from the user interface; and
providing for display the one or more metrics for the one or more deals associated with the page on the social networking system.

25. The method of claim 17, further comprising:
providing in the user interface on the application operating on the mobile device associated with the admin of the page a link for managing one or more advertising campaigns associated with the page on the social networking system;
receiving a selection of the link for managing the one or more advertising campaigns associated with the page on the social networking system from the user interface; and
responsive to the selection of the link, providing an ad campaign management user interface on the application operating on the mobile device associated with the admin of the page for managing the one or more advertising campaigns associated with the page on the social networking system.

26. The method of claim 17, further comprising:
providing in the user interface on the application operating on the mobile device associated with the admin of the page a link for managing advertising associated with the page on the social networking system;
receiving a selection of the link for managing the advertising associated with the page on the social networking system from the user interface; and
responsive to the selection of the link, providing an ad inventory management user interface on the application operating on the mobile device associated with the admin of the page for managing the advertising associated with the page on the social networking system.

27. A method comprising:
providing one or more links to select a page of a social networking system for display in a user interface on an admin application operating on a mobile device communicatively coupled with the social networking system, where the page is selected to associate a loyalty program for a place of business represented by the selected page;
receiving a plurality of definitions for a plurality of achievements in the loyalty program associated with the page representing the place of business;
receiving a selection of a plurality of rewards for completing the plurality of achievements in the loyalty program of the selected page, where each reward of the plurality of rewards is provided to a fan of the page responsive to the fan completing an achievement of the plurality of achievements in the loyalty program; and
storing the loyalty program and the plurality of rewards in association with the selected page in the social networking system.

28. The method of claim 27, wherein receiving a plurality of definitions for a plurality of achievements in the loyalty program associated with the page representing the place of business further comprises:
receiving a selection of links in the user interface on the admin application operating on a mobile device communicatively coupled with the social networking system, where the selection of links define the plurality of achievements in the loyalty program.

29. The method of claim 27, wherein receiving a plurality of definitions for a plurality of achievements in the loyalty program associated with the page representing the place of business further comprises:
receiving user input in the user interface on the admin application operating on a mobile device communicatively coupled with the social networking system, where the user input includes a definition of at least one of the plurality of achievements in the loyalty program.

30. The method of claim 27, wherein a plurality of rewards for completing the plurality of achievements in the loyalty program of the selected page further comprises a deal previously associated with the page.

31. The method of claim 27, wherein a plurality of rewards for completing the plurality of achievements in the loyalty program of the selected page further comprises a coupon for a discount on a product offered by the place of business represented by the page on the social networking system.

32. The method of claim 31, wherein the coupon for the discount on the product offered by the place of business represented by the page on the social networking system is determined by the definition of the achievement associated with the coupon.

33. The method of claim 27, further comprising:
providing in the user interface a link for displaying one or more metrics for the loyalty program associated with the page on the social networking system;
receiving a selection of the link for displaying one or more metrics for the loyalty program associated with the page on the social networking system from the user interface; and
providing for display the one or more metrics for the loyalty program associated with the page on the social networking system.

34. A method comprising:
maintaining a plurality of users connected to a page in a social networking system, where the page represents a place of business operated by a merchant that administers the page;
providing one or more deals to the plurality of users through the social networking system, where the one or more deals may be provided in coupon format;
receiving a coupon from a user of the plurality of users through a page administration application operating on a user device associated with the merchant that administers the page;
authenticating the coupon as a valid deal associated with the page for the place of business;
responsive to the coupon being successfully authenticated, sending a confirmation to the merchant through the page administration application; and
responsive to the coupon being rejected, sending a rejection notification to the merchant through the page administration application.

35. The method of claim 34, further comprising:
responsive to the coupon being successfully authenticated, providing for display one or more rewards associated with the page on the social networking system in a user interface on a user device associated with the user.

36. The method of claim 34, wherein providing one or more deals to the plurality of users through the social networking system further comprises:
providing a plurality of rewards as the one or more deals responsive to the plurality of users completing a plurality of achievements in a loyalty program associated with the page.

37. The method of claim 34, wherein providing one or more deals to the plurality of users through the social networking system further comprises:
providing a deal responsive to a user connected to the page being located near the place of business represented by the page.

38. The method of claim 34, wherein providing one or more deals to the plurality of users through the social networking system further comprises:
providing a deal responsive to a user generating a check-in event with one or more other users not connected to the page, where the check-in event indicates that the user and the one or more other users are located near the place of business represented by the page.

39. The method of claim 34, wherein providing one or more deals to the plurality of users through the social networking system further comprises:
providing a deal responsive to a user generating content on the page.

40. The method of claim 34, wherein providing one or more deals to the plurality of users through the social networking system further comprises:
providing a deal responsive to a user generating content on the page, where the content comprises a review of the place of business represented by the page.

41. The method of claim 34, further comprising:
responsive to the coupon being successfully authenticated, classifying the user for special treatment associated with the page on the social networking system in a user interface on a user device associated with the user.
